(19) United States
(12) Patent Application Publication
(10) Pub. No.: US 2016/0290242 A1
(43) Pub. Date: Oct. 6, 2016

(54) METHOD AND DEVICE FOR SETTING ACCELERATOR RESPONSE

(71) Applicant: Xiaomi Inc., Beijing (CN)

(72) Inventors: Mingyong TANG, Beijing (CN); Huayijun LIU, Beijing (CN); Tao CHEN, Beijing (CN)

(21) Appl. No.: 15/063,935

(22) Filed: Mar. 8, 2016

(30) Foreign Application Priority Data
Mar. 31, 2015 (CN) 201510148074.4

(51) Int. Cl. F02D 11/10; G01G 19/02; B60C 23/06

(52) U.S. Cl. CPC F02D 11/105; B60C 23/06; G01G 19/021

(57) ABSTRACT

A method for setting an accelerator response for a vehicle includes acquiring current load information of the vehicle and setting the accelerator response of the vehicle according to the current load information.

### CROSS-REFERENCE TO RELATED APPLICATION

This application is based upon and claims priority to Chinese Patent Application No. 201510148074.4, filed Mar. 31, 2015, the entire contents of which are incorporated herein by reference.

### TECHNICAL FIELD

The present disclosure relates to vehicles and, more particularly, to a method and a device for setting an accelerator response for a vehicle.

### BACKGROUND

An accelerator in a vehicle, such as an automobile, is used for controlling an acceleration of the automobile. Usually, the performance of the engine on the automobile does not change. Thus, when the automobile carries different loads, the accelerator response can be different. When the automobile is not loaded, the accelerator response is relatively quick. When the automobile is carrying a large load, the accelerator response is relatively slow.

### SUMMARY

In accordance with the present disclosure, there is provided a method for setting an accelerator response for a vehicle. The method includes acquiring current load information of the vehicle and setting the accelerator response of the vehicle according to the current load information.

Also in accordance with the present disclosure, there is provided a device for setting an accelerator response of a vehicle. The device includes a controller and a memory for storing instructions that, when executed by the controller, cause the controller to acquire current load information of the vehicle and set the accelerator response of the vehicle according to the current load information.

Also in accordance with the present disclosure, there is provided a non-transitory computer-readable storage medium storing instructions that, when executed by a controller in a vehicle, cause the controller to acquire current load information of the vehicle and set an accelerator response of the vehicle according to the current load information.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates a structural schematic diagram of one implementation circumstance for a method according to one exemplary embodiment of the present disclosure.

FIG. 2A illustrates a flowchart of a method according to one exemplary embodiment of the present disclosure.

FIG. 2B illustrates a flowchart of a method according to another exemplary embodiment of the present disclosure.

FIG. 3 illustrates a flowchart of a method according to another exemplary embodiment of the present disclosure.

FIG. 4 illustrates a flowchart of a method according to another exemplary embodiment of the present disclosure.

FIG. 5 illustrates a block diagram of a device according to one exemplary embodiment of the present disclosure.

FIG. 6 illustrates a block diagram of a device according to another exemplary embodiment of the present disclosure.

FIG. 7 illustrates a block diagram of a device according to another exemplary embodiment of the present disclosure.

Specific embodiments in this disclosure have been shown by way of examples in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with some aspects related to the invention as recited in the appended claims.

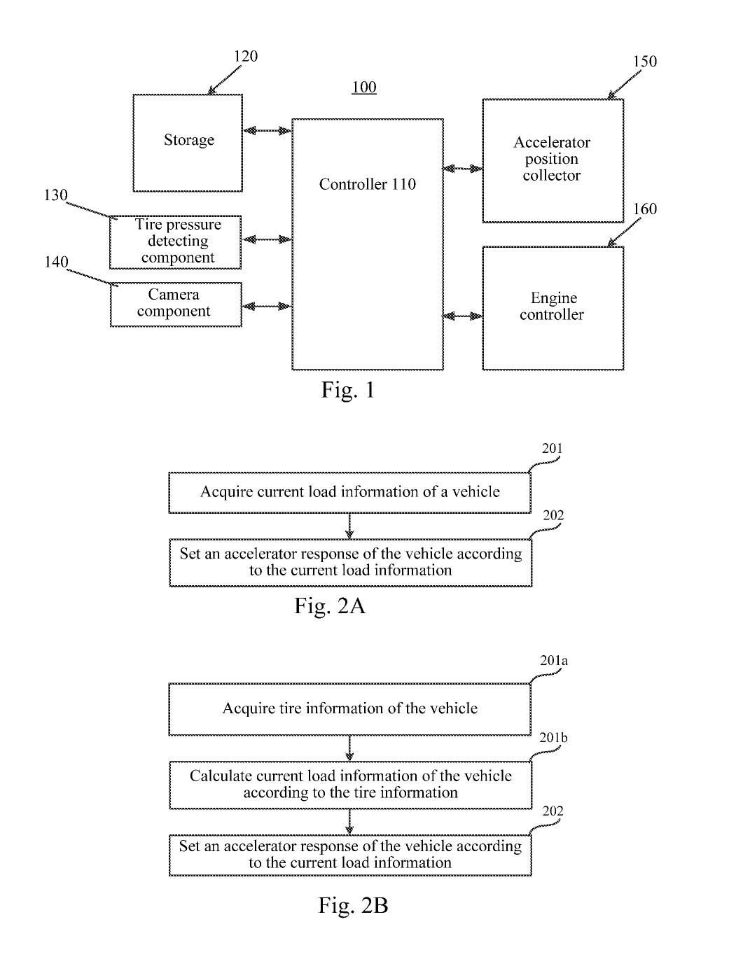

FIG. 1 illustrates a structural schematic diagram of one implementation circumstance for a method for setting an accelerator response, according to one exemplary embodiment of the present disclosure. The implementation circumstance is a vehicle including an electronic accelerator control system 100. The vehicle may be an electric vehicle or a gas vehicle. The vehicle may be a vehicle having two wheels, three wheels, four wheels, or more than four wheels. The electronic accelerator control system 100 includes a controller 110, a storage 120, a tire pressure detecting component 130, a camera component 140, an accelerator position collector 150, and an engine controller 160.

The controller 110 may be a micro control unit (MCU). The controller 110 is electronically coupled with the storage 120, the tire pressure detecting component 130, the camera component 140, the accelerator position collector 150, and the engine controller 160, respectively.

The tire pressure detecting component 130 is used for collecting tire information of tire(s) of the vehicle, and sending the tire information to the controller 110.

The camera component 140 is used for collecting tire pictures of the vehicle, and sending the tire pictures to the controller 110. The camera component 140 is usually provided over a lateral side of a tire of the vehicle.

The accelerator position collector 150 may be a pressure sensor or a displacement sensor, and is used for collecting a position state of the accelerator and sending the position state of the accelerator to the controller 110. The accelerator in a gas vehicle is usually a mechanical device, and the accelerator in an electric vehicle is usually a sliding potentiometer.

The engine controller 160 can be an electrical air throttle in a gas vehicle, or an electrical speed regulator in an electric vehicle. The engine controller 160 is used for controlling an output torque of the engine of the vehicle.

Although FIG. 1 shows both the tire pressure detecting component 130 and the camera component 140, an electronic accelerator control system consistent with the present disclosure can include both components, such as the electronic accelerator control system 100, or can include only one of the tire pressure detecting component 130 or the camera component 140.

FIG. 2A illustrates a flowchart of a method for setting an accelerator response, according to one exemplary embodiment of the present disclosure. The method can be implemented, for example, in the implementation circumstance shown in FIG. 1. As shown in FIG. 2A, at 201, current load information of a vehicle is acquired. The current load information refers to a weight of object(s) carried by the vehicle. At 202, an accelerator response of the vehicle is set according to the current load information. The accelerator response refers to an acceleration provided to the vehicle by a torque outputted from the engine when a certain displacement of the accelerator, also referred to as “accelerator displacement,” occurs.

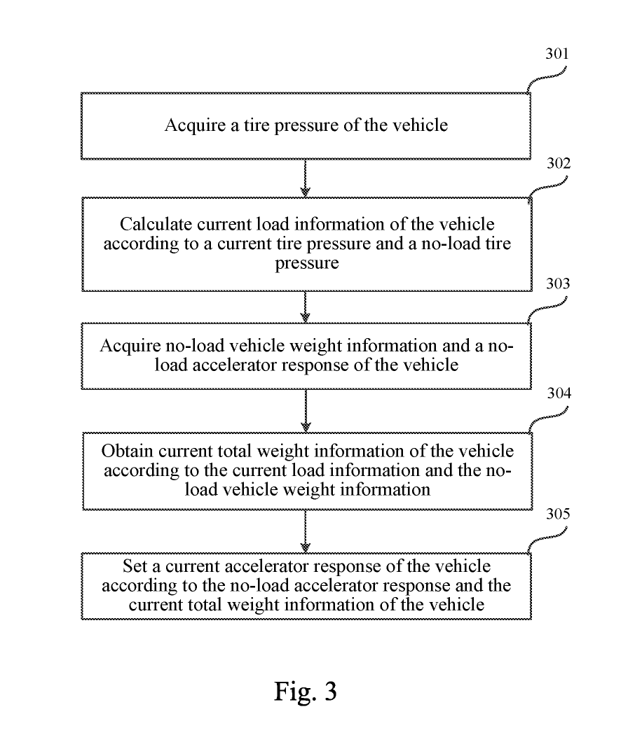

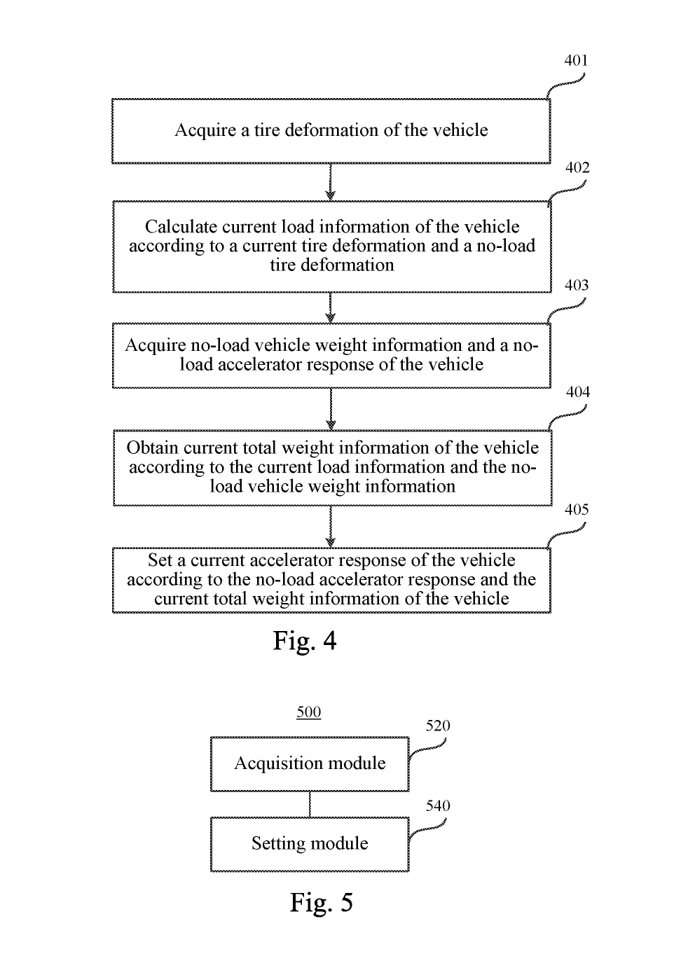

In some embodiments, as shown in FIG. 2B, acquiring the current load information, i.e., 201 in FIG. 2A, can include acquiring tire information of the vehicle (201a in FIG. 2B) and calculating the current load information of the vehicle according to the tire information (201b in FIG. 2B). The tire information includes at least one of a tire pressure or a tire deformation. Embodiments using the tire pressure and embodiments using the tire deformation are separately described below in connection with FIGS. 3 and 4.

As shown in FIG. 3, at 301, the controller 110 acquires a tire pressure of the vehicle. In some embodiments, the controller 110 acquires the tire information of the vehicle, for example, via the tire pressure detecting component 130.

At 302, the controller 110 calculates current load information of the vehicle according to a current tire pressure and a no-load tire pressure. The no-load tire pressure refers to a tire pressure of the vehicle when the vehicle does not carry a load. For example, a pressure difference-load corresponding relationship between the tire pressure difference and the load is pre-stored in the storage 120. The tire pressure difference refers to a difference between the current tire pressure and the no-load tire pressure. The pressure difference-load corresponding relationship can be a positive correlative curve. That is, a larger tire pressure difference indicates a larger load and a smaller tire pressure difference indicates a smaller load. The current load information can be obtained based on the tire pressure difference and the pressure difference-load corresponding relationship.

At 303, the controller 110 acquires no-load vehicle weight information and a no-load accelerator response of the vehicle. The no-load vehicle weight information refers to information about the weight of the vehicle when the vehicle does not carry a load. The no-load vehicle weight information can be pre-stored in the storage 120 and can be read by the controller 110 when needed. Alternatively, the controller 110 can acquire model information of the vehicle, and, according to the model information, acquire the no-load vehicle weight information from a network or from a corresponding relationship between the model and the no-load vehicle weight. The no-load accelerator response can be a corresponding relationship between an accelerator displacement and an output torque of the engine when the vehicle does not carry a load. The no-load accelerator response can also be pre-stored in the storage 120.

At 304, the controller 110 obtains current total weight information of the vehicle according to the current load information and the no-load vehicle weight information. For example, the controller adds the current load information to the no-load vehicle weight information to obtain the current total weight information of the vehicle.

At 305, the controller 110 sets a current accelerator response of the vehicle according to the no-load accelerator response and the current total weight information of the vehicle. In some embodiments, the current accelerator response is set such that the acceleration of the vehicle corresponding to the no-load accelerator response and the acceleration of the vehicle corresponding to the current accelerator response are the same or similar with the same or similar accelerator displacement.

For example, assuming that the no-load vehicle weight information is W1 and the current load information is W2, then the current total weight information is W1+W2. When the accelerator displacement is d and the output torque of the engine corresponding to the no-load accelerator response is T1, then the output torque of the engine corresponding to the current accelerator response T2 approximately satisfies the following equation.

T1/W1=T2/(W1+W2).

The controller 110 can set the current accelerator responses within the entire displacement range of the accelerator according to the above equation, or can set the current accelerator responses within a part of the displacement range of the accelerator according to the above equation.

FIG. 4 illustrates a flowchart of a method for setting an accelerator response, according to another exemplary embodiment of the present disclosure, in which the tire deformation is used as the tire information. As shown in FIG. 4, at 401, the controller 110 acquires the tire deformation of the vehicle. In some embodiments, the controller 110 acquires image information of a tire of the vehicle via the camera component 140, and extracts the tire deformation of the tire according to the image information.

At 402, the controller calculates current load information of the vehicle according to a current tire deformation and a no-load tire deformation. The no-load tire deformation refers to a tire deformation of the vehicle when the vehicle does not carry a load. For example, a deformation difference-load corresponding relationship between the tire deformation difference and the load is pre-stored in the storage 120. The deformation difference-load corresponding relationship can be a positive correlative curve. That is, a larger tire deformation difference indicates a larger load and a smaller tire deformation difference indicates a smaller load. The current carrying capacity information can be obtained based on the tire deformation difference and the deformation difference-load corresponding relationship.

At 403, the controller 110 acquires no-load vehicle weight information and a no-load accelerator response of the vehicle. At 404, the controller 110 obtains current total weight information of the vehicle according to the current load information and the no-load vehicle weight information. At 405, the controller 110 sets a current accelerator response of the vehicle according to the no-load accelerator response and the current total weight information of the vehicle. Processes of 403, 404, and 405 are similar to those of 303, 304, and 305 shown in FIG. 3, respectively, and thus detailed descriptions of 403, 404, and 405 are omitted here.

In the examples described above, the tire pressure or the tire deformation is used to calculate the current load information. In some embodiments, the controller 110 can also calculate the current load information according to both the tire pressure and the tire deformation. For example, the controller 110 can calculate a first current load information according to the tire pressure, calculate a second current load information according to the tire deformation, and obtain the current load information by calculating a weighted average of the first current load information and the second current load information.

FIG. 5 illustrates a block diagram of a device 500 for setting an accelerator response of a vehicle, according to one exemplary embodiment of the present disclosure. The device 500 can be implemented as a part or a whole of the controller 110 in the electronic accelerator control system 100 by software, hardware, or a combination thereof. As shown in FIG. 5, the device 500 includes an acquisition module 520 and a setting module 540. The acquisition module 520 is configured to acquire current load information of the vehicle. The setting module 540 is configured to set an accelerator response of the vehicle according to the current load information.

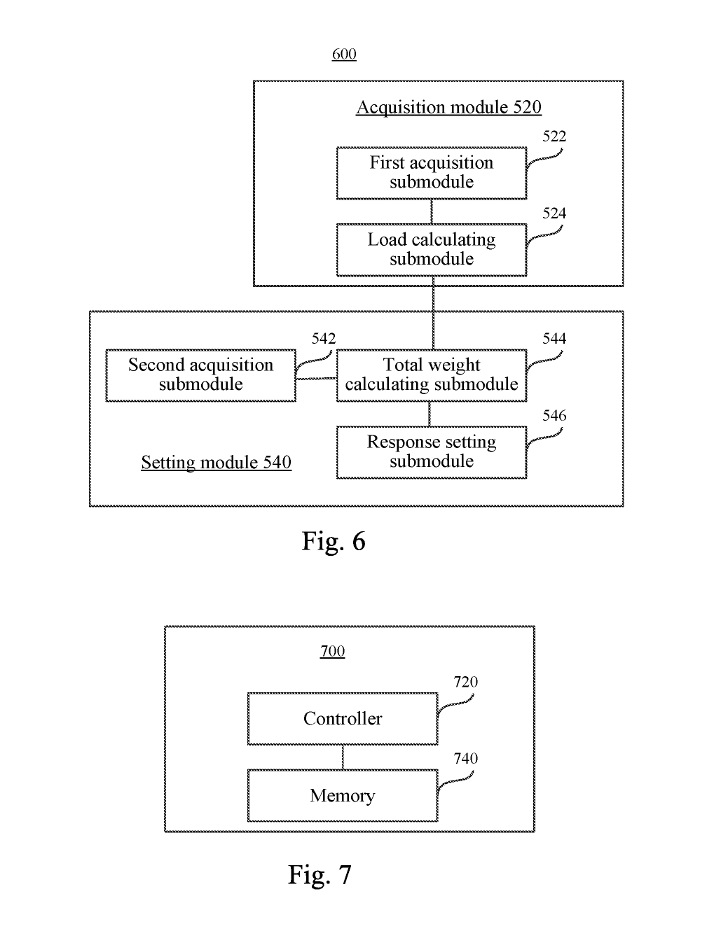

FIG. 6 illustrates a block diagram of a device 600 for setting an accelerator response of a vehicle, according to another exemplary embodiment of the present disclosure. The device 600 can be implemented as a part or a whole of the controller 110 in the electronic accelerator control system 100 by software, hardware, or a combination thereof. As shown in FIG. 6, the device 600 includes the acquisition module 520 and the setting module 540.

In some embodiments, as shown in FIG. 6, the acquisition module 520 includes a first acquisition submodule 522 and a load calculating submodule 524. The first acquisition submodule 522 is configured to acquire tire information of the vehicle. The tire information includes at least one of a tire pressure or a tire deformation. The load calculating submodule 524 is configured to calculate current load information of the vehicle according to the tire information.

For example, the load calculating submodule 524 is configured to calculate the current load information of the vehicle according to a current tire pressure and a no-load tire pressure. Alternatively, the load calculating submodule 524 is configured to calculate the current load information of the vehicle according to a current tire deformation and a no-load tire deformation.

In some embodiments, as shown in FIG. 6, the setting module 540 includes a second acquisition submodule 542, a total weight calculating submodule 544, and a response setting submodule 546. The second acquisition submodule 542 is configured to acquire no-load vehicle weight information and a no-load accelerator response of the vehicle. The total weight calculating submodule 544 is configured to obtain current total weight information of the vehicle according to the current load information and the no-load vehicle weight information. The response setting submodule 546 is configured to set a current accelerator response of the vehicle according to the no-load accelerator response and the current total weight information of the vehicle.

Specific manners of operation of individual modules are similar to those described above with respect to methods consistent with the present disclosure, and thus description thereof is omitted here.

FIG. 7 illustrates a block diagram of a device 700 for setting an accelerator response of a vehicle, according to another exemplary embodiment of the present disclosure. The device 700 includes a controller 720 and a memory 740 storing instructions executable by the controller 720.

The controller 720 typically controls overall operations of the device 700. The controller 720 may include one or more processing cores to execute instructions to perform all or part of the methods consistent with the present disclosure, such as those described above. Moreover, the controller 720 may include one or more modules which facilitate the interaction between the controller 720 and other components. For example, the controller 720 may include a tire pressure detecting module to facilitate the interaction between the tire pressure detecting component 130 and the controller 720.

The memory 740 is configured to store various types of data to support the operation of the device 700. Examples of such data include instructions for any applications or methods operated on the device 700. The memory 740 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

The controller 720 is configured to perform methods for setting an accelerator response consistent with the present disclosure, such as those described above.

In exemplary embodiments, there is also provided a non-transitory computer-readable storage medium storing instructions, such as included in the memory 740, executable by the controller 720 in the device 700, for performing methods consistent with the present disclosure, such as those described above. For example, the non-transitory computer-readable storage medium may be a ROM, a RAM, a CD-ROM, a magnetic tape, a floppy disc, an optical data storage device, or the like.

According to the present disclosure, the accelerator response of a vehicle is set according to the current load and the accelerator response can be kept the same or similar under different load conditions. More specifically, the load accelerator response under a current load condition can be set to be the same as or similar to that without a load, such that the vehicle can acquire the same acceleration under different load conditions. Thus, the driver does not feel an acceleration lag when the load of the vehicle is large.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for setting an accelerator response for a vehicle, comprising:
acquiring current load information of the vehicle; and
setting the accelerator response of the vehicle according to the current load information.

2. The method according to claim 1, wherein acquiring the current load information includes:
acquiring tire information of the vehicle, the tire information including at least one of a tire pressure or a tire deformation; and
calculating the current load information according to the tire information.

3. The method according to claim 2, wherein setting the accelerator response includes:
acquiring no-load vehicle weight information and a no-load accelerator response of the vehicle;
obtaining current total weight information of the vehicle according to the current load information and the no-load vehicle weight information; and
setting the accelerator response according to the no-load accelerator response and the current total weight information.

4. The method according to claim 2, wherein:
the tire information includes the tire pressure, and
calculating the current load information includes calculating the current load information of the vehicle according to a current tire pressure and a no-load tire pressure.

5. The method according to claim 4, wherein setting the accelerator response includes:
acquiring no-load vehicle weight information and a no-load accelerator response of the vehicle;
obtaining current total weight information of the vehicle according to the current load information and the no-load vehicle weight information; and
setting the accelerator response according to the no-load accelerator response and the current total weight information.

6. The method according to claim 2, wherein:
the tire information includes the tire deformation, and
calculating the current load information includes calculating the current load information according to a current tire deformation and a no-load tire deformation.

7. The method according to claim 6, wherein setting the accelerator response includes:
acquiring no-load vehicle weight information and a no-load accelerator response of the vehicle;
obtaining current total weight information of the vehicle according to the current load information and the no-load vehicle weight information; and
setting the accelerator response according to the no-load accelerator response and the current total weight information.

8. The method according to claim 1, wherein setting the accelerator response includes:
acquiring no-load vehicle weight information and a no-load accelerator response of the vehicle;
obtaining current total weight information of the vehicle according to the current load information and the no-load vehicle weight information; and
setting the accelerator response according to the no-load accelerator response and the current total weight information.

9. A device for setting an accelerator response of a vehicle, comprising:
a controller; and
a memory for storing instructions that, when executed by the controller, cause the controller to:
acquire current load information of the vehicle; and
set the accelerator response of the vehicle according to the current load information.

10. The device according to claim 9, wherein the instructions further cause the controller to:
acquire tire information of the vehicle, the tire information including at least one of a tire pressure or a tire deformation; and
calculate the current load information according to the tire information.

11. The device according to claim 10, wherein the instructions further cause the controller to:
acquire no-load vehicle weight information and a no-load accelerator response of the vehicle;
obtain current total weight information of the vehicle according to the current load information and the no-load vehicle weight information; and
set the accelerator response according to the no-load accelerator response and the current total weight information.

12. The device according to claim 10, wherein the instructions further cause the controller to:
calculate the current load information according to a current tire pressure and a no-load tire pressure.

13. The device according to claim 12, wherein the instructions further cause the controller to:
acquire no-load vehicle weight information and a no-load accelerator response of the vehicle;
obtain current total weight information of the vehicle according to the current load information and the no-load vehicle weight information; and
set the accelerator response according to the no-load accelerator response and the current total weight information.

14. The device according to claim 10, wherein the instructions further cause the controller to:
calculate the current load information according to a current tire deformation and a no-load tire deformation.

15. The device according to claim 14, wherein the instructions further cause the controller to:
acquire no-load vehicle weight information and a no-load accelerator response of the vehicle;
obtain current total weight information of the vehicle according to the current load information and the no-load vehicle weight information; and
set the accelerator response according to the no-load accelerator response and the current total weight information.

16. The device according to claim 9, wherein the instructions further cause the controller to:
acquire no-load vehicle weight information and a no-load accelerator response of the vehicle;
obtain current total weight information of the vehicle according to the current load information and the no-load vehicle weight information; and
set the accelerator response according to the no-load accelerator response and the current total weight information.

17. A non-transitory computer-readable storage medium storing instructions that, when executed by a controller in a vehicle, cause the controller to:
acquire current load information of the vehicle; and
set an accelerator response of the vehicle according to the current load information.
